(19) United States
(12) Patent Application Publication
(10) Pub. No.: US 2024/0015660 A1
(43) Pub. Date: Jan. 11, 2024

(54) POWER GUIDANCE FOR BATTERY-POWERED IOT AND SMART DEVICES

(71) Applicant: Cisco Technology, Inc., San Jose, CA (US)

(72) Inventors: Ram Mohan RAVINDRANATH, Bangalore (IN); Vinay SAINI, Bengaluru (IN); Rajesh I. VISWAMBHARAN, Bangalore (IN); Jerome HENRY, Pittsboro, NC (US); Robert E. BARTON, Richmond (CA)

(21) Appl. No.: 18/297,212

(22) Filed: Apr. 7, 2023

(30) Foreign Application Priority Data
Jul. 11, 2022 (IN) 202241039823

(51) Int. Cl. H04W 52/02

(52) U.S. Cl. CPC H04W 52/0277; H04W 52/0216

(57) ABSTRACT

Methods and a system described herein manage the power of IoTs and smart devices operating on a wireless network. When an access point coupled to the network receives a low power indication from a battery-powered IoT or smart device, it may take several actions in response. In one case, it extends the target wake time to become longer and longer to preserve the device's battery. In addition, the device changes its operation to conserve power. In another case, it provides power over the wireless network to the wireless device. The access point restores the target wake time when the device returns to a power-ok condition. The device resumes operation according to the parameters in effect before the low power condition occurs.

### CROSS-REFERENCE TO RELATED APPLICATIONS

This application claims benefit of co-pending Indian provisional patent application Serial No. 202241039823 filed Jul. 11, 2022. The aforementioned related patent application is herein incorporated by reference in its entirety.

### TECHNICAL FIELD

Embodiments presented in this disclosure generally relate to wireless networks. More specifically, embodiments disclosed herein include the operation of wireless networks with battery-powered stations.

### BACKGROUND

Wireless standards 802.11ah and 802.11ax develop battery-powered Wi-Fi IoT features to allow low throughput and low-power communication. Among these IoT-friendly features, target wakeup time (TWT) enables a station and an access point to negotiate the station wake interval and duration. After successful TWT negotiation, stations are allowed to enter the doze state and (mostly) stop consuming power without losing their 802.11 association.

TWT is well adapted for the IoT use case, as IoT device traffic is usually well understood, with clear transmission periodicity, latency, and throughput requirements. TWT is also attractive for smart devices (like smartwatches) to avoid battery drain, even if their traffic structure is more stochastic.

However, TWT only solves wake periodicity. In the real world, battery-operated IoT objects change their power behavior when the battery drains out beyond specific thresholds (e.g., 20% battery charge on some consumer electronics), implementing conservative measures to delay battery further drainage. At that time, the object network behavior also should change, but 802.11ax/be does not implement a mechanism to facilitate this case.

### BRIEF DESCRIPTION OF THE DRAWINGS

FIG. 1 depicts a representative access point, according to embodiments.

FIG. 2 depicts an access point in wireless communication with groups of Internet of things (IoT) devices, according to embodiments.

FIG. 3A depicts a flow of operations for a low-power warning response, according to an embodiment.

FIG. 3B depicts a flow of operations for a low-power warning response, according to an embodiment.

FIG. 3C depicts a flow of operations for an access point response to a low-power warning, according to an embodiment.

FIG. 4 depicts a flow of operations for a station, according to embodiments.

FIG. 5A depicts a flow of operations for a handlePowerCondition function described in reference to FIG. 4, according to an embodiment.

FIG. 5B depicts a flow of operations for a handlePowerCondition function described in reference to FIG. 4, according to another embodiment.

FIG. 6 depicts a flow of operations for an access point response to a low power warning from a battery discharge characteristic of a device, according to an embodiment.

### DESCRIPTION OF EXAMPLE EMBODIMENTS

### Overview

One embodiment is a method for managing battery power of a station in a wireless network. The method includes receiving a message from the station operating in a power savings mode, where the message indicates that the battery power at the station has fallen below a threshold and that the station can receive power over the wireless network, and the station, in response to the battery power having fallen below the threshold, wakes up a radio interface of the station to send the message. The method further includes transmitting an action frame to the station in response to the message, indicating a channel and parameters for the station to receive power over the wireless network, and providing power to the station over the wireless network according to the action frame.

Another embodiment is a system for managing battery power of a station in a wireless network. The system includes at least one station configured to connect to the wireless network and at least one access point configured to connect to the wireless network. At least one of the access points is configured to receive a message from the at least one station operating in a power savings mode. The message indicates that the battery power at the one station has fallen below a threshold and that the one station can receive power over the wireless network. The one station wakes up a radio interface of the station to send the low battery power message. The one access point is further configured to transmit, in response to the message, an action frame to the one station indicating a channel and parameters for the one station to receive power over the wireless network and then to provide power to the one station over the wireless network according to the action frame.

Yet another embodiment is a non-transitory computer-readable medium encoding instructions, which, when executed by a processor of an access point coupled to a wireless network, cause the access point to receive a message from a station operating in a power savings mode, where the message indicates that the battery power at the station has fallen below a threshold and that the station can receive power over the wireless network. The station wakes up a radio interface of the station to send the message. The instructions further cause the access point to transmit, in response to the message, an action frame to the station indicating a channel and parameters for the station to receive power over the wireless network and then to provide power to the station over the wireless network according to the action frame.

### Example Embodiments

Described herein are systems and methods for a station to notify an access point when power is low, dynamically trigger the access point to conserve the station power, and, if the access point or a neighboring access point supports ‘power over Wi-Fi’ to provide far-field wireless power to help recharge the station. The method allows an access point to efficiently manage power consumption for IoT devices when devices reach low battery mode.

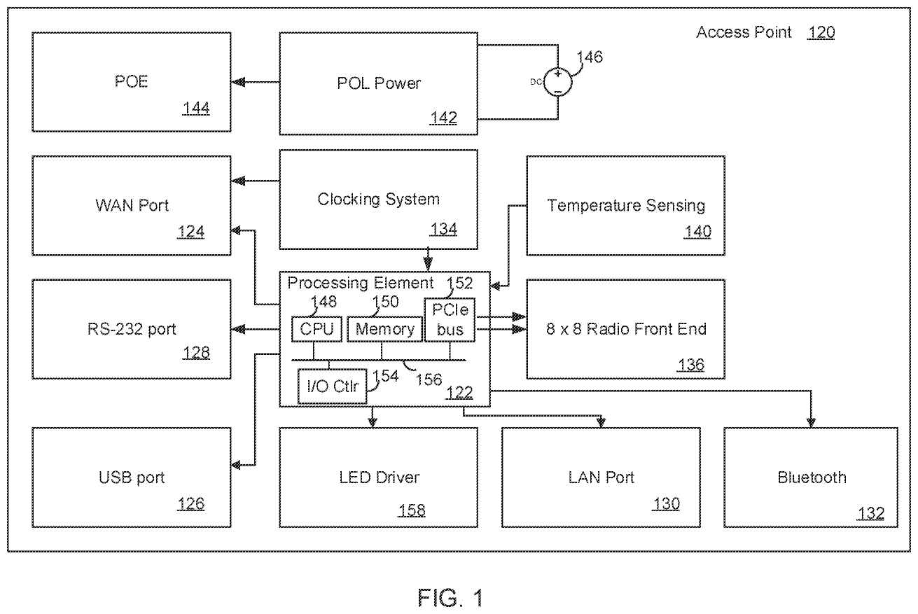

FIG. 1 depicts a representative access point. FIG. 1B depicts a representative architecture of an access point. The access point 120 includes a processing element 122 and several ports or connection facilities, such as a WAN port 124, USB port 126, RS-232 port 128, LAN port 130, and Bluetooth 132. Also included are a clocking system 134 and an 8×8 radio front-end 136 with a transmitter and receiver, which are coupled to eight external antennas. Auxiliary modules include a temperature sensing module 140, a power module 142 connected to a DC power source 146, a power over Ethernet (POE) module 144, and LED Driver 158. Processing element 122 includes a CPU 148 and memory 150, a peripheral control interconnect express (PCIe) bus controller 152 for connecting to the radio front-end 136, and an I/O controller 154, all coupled to each other via bus 156.

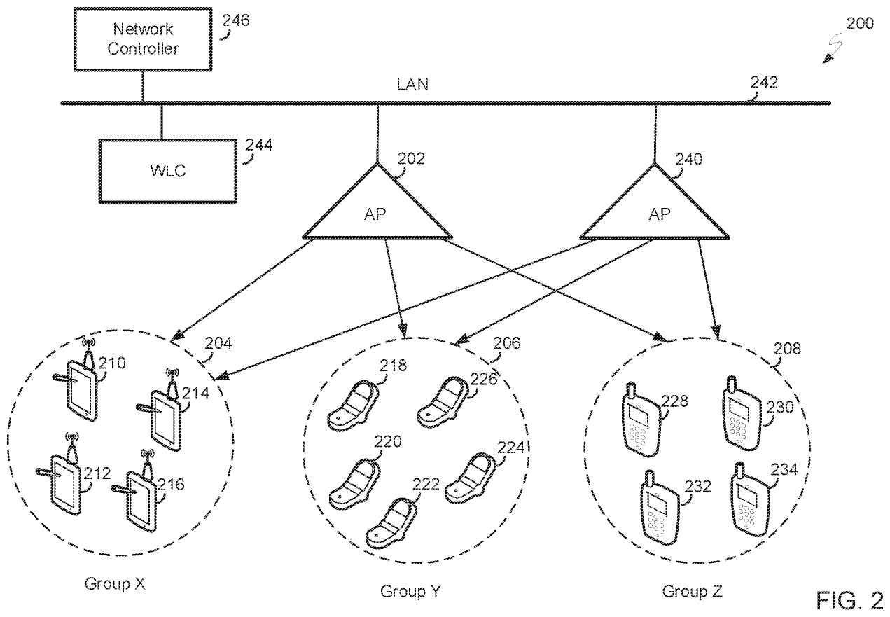

FIG. 2 depicts an access point in wireless communication with groups of IoT devices. Access points 202, 240, similar to access point 120, are coupled to a LAN 242 and wirelessly coupled to stations in Groups X 204, Y 206, and Z 208, defining a basic service set (BSS). The figure also depicts a wireless LAN controller (WLC) 244 for providing communication between access points 202, 240 and a network controller 246 for managing higher-level network functions for infrastructure 200.

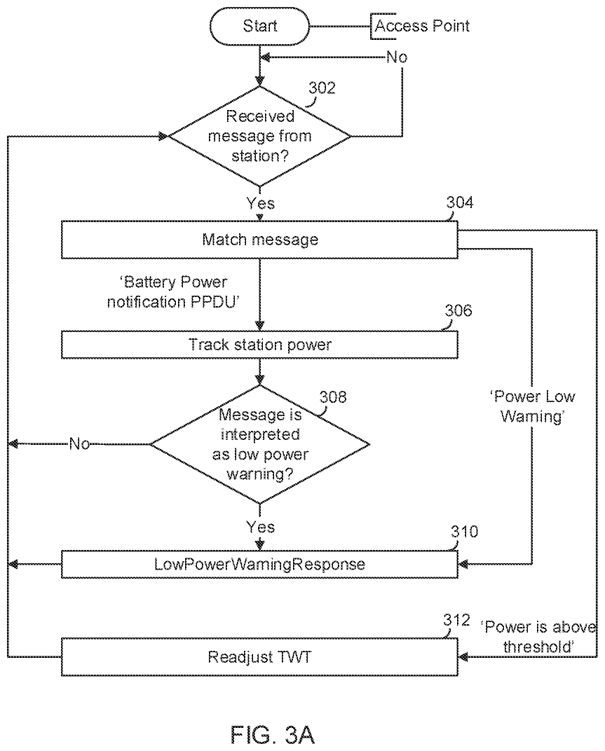

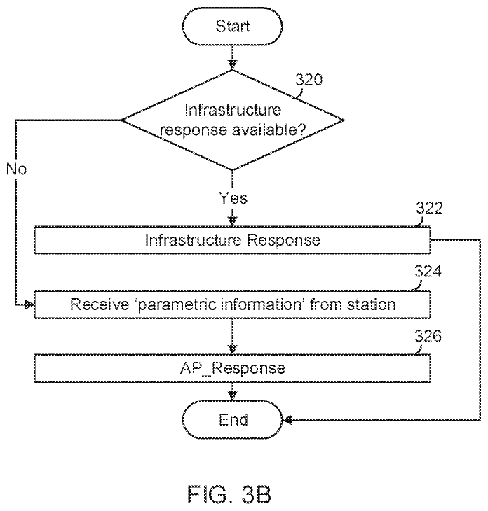

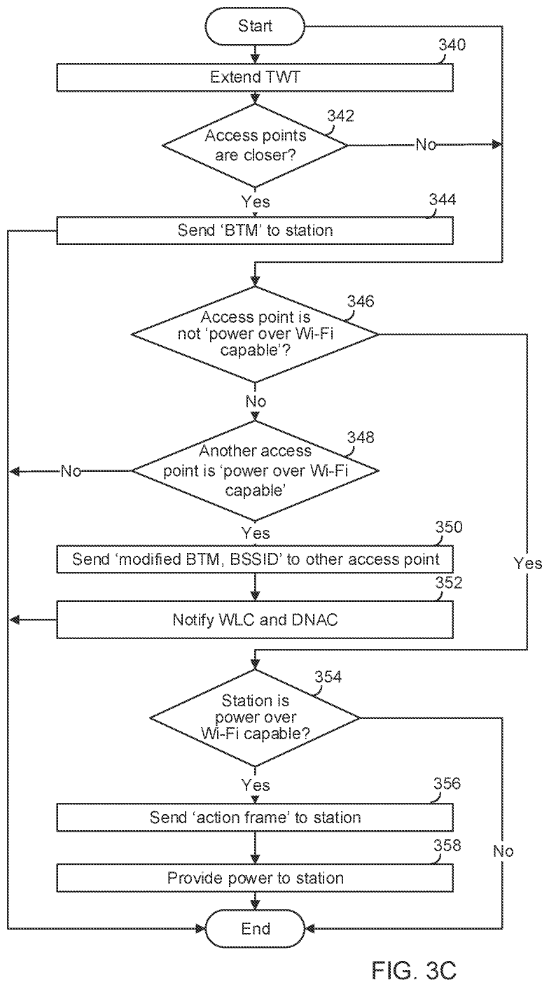

FIGS. 3A-3D depict operations of either the infrastructure or an access point to a low-power condition in a station. In particular, FIG. 3A depicts the interpretation of low-power messages from a station. FIG. 3B depicts whether the infrastructure or the access point provides the response to the low power condition in the station. FIG. 3C depicts several ways in which the access point can respond. FIG. 3D depicts an alternative response to FIG. 3C.

Referring now to FIG. 3A, the figure depicts a flow of operations for a low-power warning response, according to an embodiment. In block 302, access point 202 determines whether the access point has received a message from a station, such as station 234. If so, access point 202 matches in block 304 the message to one of several messages it can receive. If the message is a ‘Battery Power Notification PPDU’ message, then in block 306, access point 202 begins to track the battery consumption of the stations. The Battery Power Notification PPDU may either be a specific action frame or an information element (IE) carried on other frames destined for access point 202. Access point 202 in block 308 determines whether the ‘Battery Power Notification PPDU’ message can be interpreted as a ‘lower power warning’ message. If access point 202 so interprets the message, then either access point 202 or infrastructure 200 provides a LowPowerWarningResponse in block 310, according to FIGS. 3B-3C. If the received message is an explicit ‘Power Low’ warning message, then the LowPowerWarningResponse is also provided in block 310. If the message is a ‘Power is above threshold’ message, then access point 202 readjusts the TWT in block 312.

FIG. 3B depicts a flow of operations for a low-power warning response, according to an embodiment. In block 320, access point 202 determines whether an infrastructure response is available in response to a ‘low power warning’ message or a ‘power low warning’ message. If so, then in block 322, infrastructure 200 responds. Through MUD or thresholds communicated to infrastructure 200 as part of the initial registration to access point 202 or WLC 244, infrastructure 200 has parameters that specify the operation of stations at low power and operates the stations accordingly. If not, then in block 324, access point 202 receives parametric information from the station, and in block 326 provides the response according to FIG. 3C. The parametric information includes:
1. Status (e.g., a binary status, 00=good, 01=low power; or a battery percentage status (e.g., 20%); or a projected remaining battery lifetime value (e.g., 40 min);
2. Conservation measures (e.g., single stream only, binary or quadrature phase key (BPSK/QPSK) modulation only, direct sequence spread spectrum (DSSS) only, no acknowledgment of frames (ACK) only, targeted (lower) data delivery pace, etc.;
3. Power over Wi-Fi chargeable capability, e.g., 1 bit.

FIG. 3C depicts a flow of operations for an access point response to a low-power warning, according to an embodiment. In block 340, access point 202 extends the TWT to put the device into a ‘battery preservation mode’ in accordance with a station Manufacturer Usage Description (MUD) profile as shared with the infrastructure. The MUD profile provides a link to a file in a public network server, where the file contains parameters needed by an IoT device for normal operation. The infrastructure retrieves the parameters from the file. When the access point interprets that the station's battery is getting low (or after it explicitly receives the low power warning), it begins extending the TWT, allowing the station to spend more time in stasis. At each interval, as the station battery power diminishes, the TWT may become exponentially longer, allowing the preservation of the battery power for as long as possible.

In block 342, access point 202 determines whether there are access points, such as access point 240, closer to station 234. If so, in block 344, access point 202 sends a modified basic transition message (BTM) to station 234, suggesting roaming with an estimated power budget for the new link with station 234.

In block 346, access point 202 determines whether it is ‘power over Wi-Fi’ capable. If not, in block 348, access point 202 determines whether another neighboring access point 240 is capable of ‘power over Wi-Fi.’ If so, then in block 350, access point 202 sends a ‘modified BTM, basic service set ID (BSSID)’ message to the another access point 240. In block 352, access point 202 notifies the WLC 244 or a network controller 246 of the station's condition.

In block 354, if access point 202 is capable of ‘power over Wi-Fi’ and station 234 is also capable of ‘power over Wi-Fi,’ then in block 356, access point 202 sends an ‘action frame’ to station 234. In block 358, access point 202 provides power to station 234.

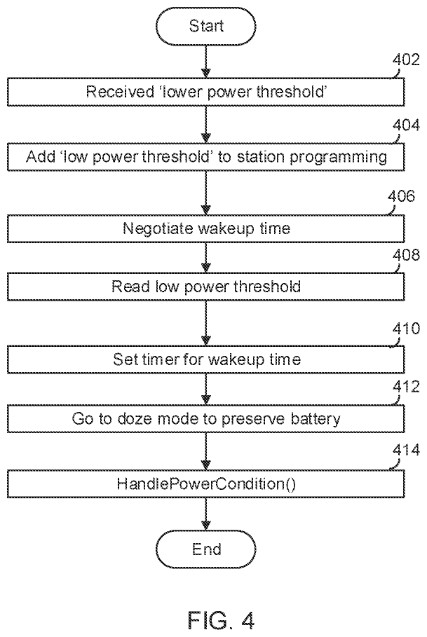

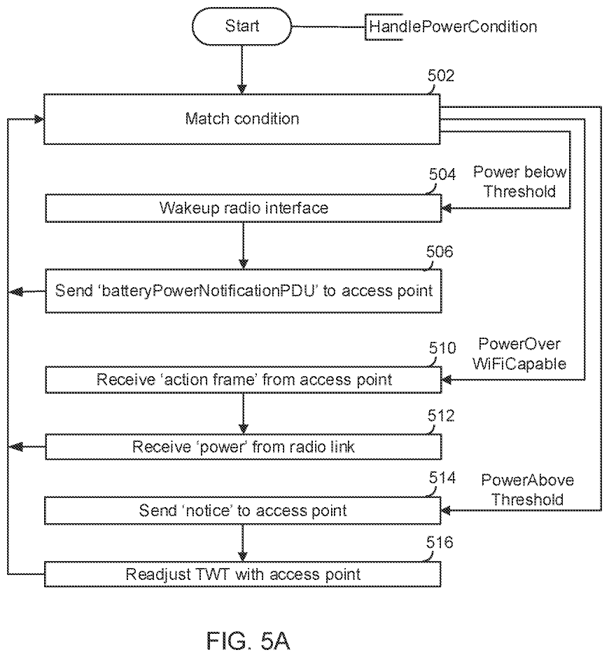

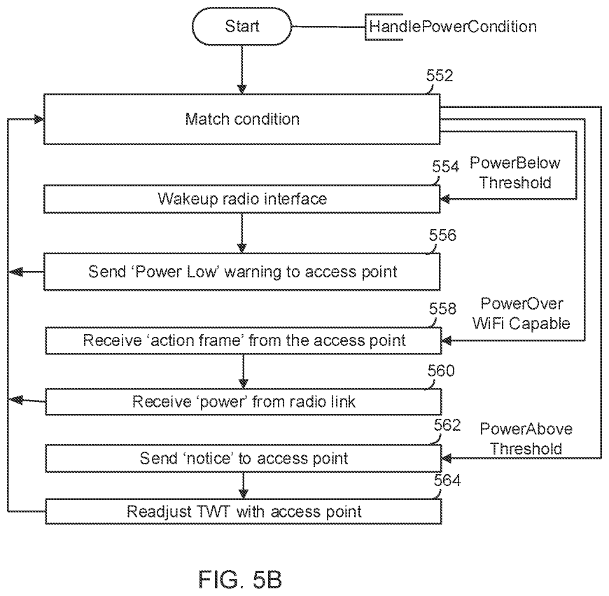

FIGS. 4, 5A, and 5B depict operations for a station handling its low power condition. In particular, FIG. 4 depicts operations for a station entering the doze mode. FIG. 5A depicts how the station handles various power conditions that occur while in doze mode in one embodiment. FIG. 5B depicts how the stations handle the various power condition while in doze mode in an alternative embodiment.

Referring now to FIG. 4, the figure depicts a flow of operations for a station entering doze mode, according to embodiments. In block 402, the station receives a low power threshold value that was communicated to the infrastructure as part of the initial registration of access point 202 to the WLC 244, for example, through MUD, as described above. This communication could be manufacture-driven settings (like default values of a low threshold for power parameters).

In block 404, station 234 adds the received ‘low-power’ threshold, however obtained, to its programming.

In block 406, station 234 uses TWT techniques to negotiate wakeup time with its access point 202.

In block 408, station 234 reads the low power threshold, which it installed in its programming in block 402, and in block 410 sets a timer internally for a wakeup time. In block 412, station 234 enters ‘doze’ mode to preserve its battery.

In block 414, station 234 handles a power condition that may arise while the station is in ‘doze’ mode according to a HandlePowerCondition function described below.

FIG. 5A depicts a flow of operations for a HandlePowerCondition function described in reference to FIG. 4, according to an embodiment.

In block 502, the handlePowerCondition function being executed by station 234 matches a current power condition to one of three possible ones, including ‘PowerBelowThreshold,’ ‘PowerOverWi-FiCapable,’ and ‘Power AboveThreshold.’

In block 504, if the current power condition is ‘PowerBelowThreshold,’ station 234 wakes up its radio interface in block 506 and sends a ‘batteryPowerNotification PDU’ message to its access point 202, which the access point 202 receives in block 304 of FIG. 3. The access point 202 responds to the ‘batteryPowerNotification PDU’ according to blocks 306, 308, 310 in FIG. 3A.

If the current power condition is ‘PowerOverWiFiCapable,’ then in block 510, station 234 receives an action frame from its access point 202, according to block 356 in FIG. 3C. In block 512, station 234 receives power from a radio link of either its access point 202 or a neighboring access point 240, according to blocks 346-358 of FIG. 3C.

If the power condition is ‘PowerAboveThreshold,’ in block 514, station 234 sends a ‘notice’ of this condition to its access point, and in block 516, readjusts the TWT with its access point 202. The readjustment restores the TWT to the original period, removing the ‘battery preservation mode’ operation. Station 234 operates with its full-charge communication parameters, e.g., two simultaneous radio links and 1024 QAM are resumed.

FIG. 5B depicts a flow of operations for a handlePowerCondition function described in reference to FIG. 4, according to another embodiment. In this embodiment, station 234, in response to a ‘PowerBelowThreshold’ condition determined in block 552, wakes up its radio interface in block 554 and sends in block 556 a ‘Power Low’ warning to access point 202 instead of the ‘batteryPowerNotificationPDU.’ As described above, the ‘Power Low’ warning contains parametric information, such as battery status, conservation measures, and whether the station can receive power over the wireless network.

In block 558, in response to its ‘PowerOverWiFiCapable’ condition, station 234 receives an action frame from the access point 202, and in block 558 receives power from a radio link of either its access point 202 or a neighboring access point 240 in block 560.

In block 562, station 234, in response to a ‘PowerAboveThreshold’ condition, sends notice of the condition to access point 202 in block 562 and readjusts the TWT with its access point 202 in block 564. Station 234 operates with its full-charge communication parameters, e.g., two simultaneous radio links and 1024 QAM are resumed.

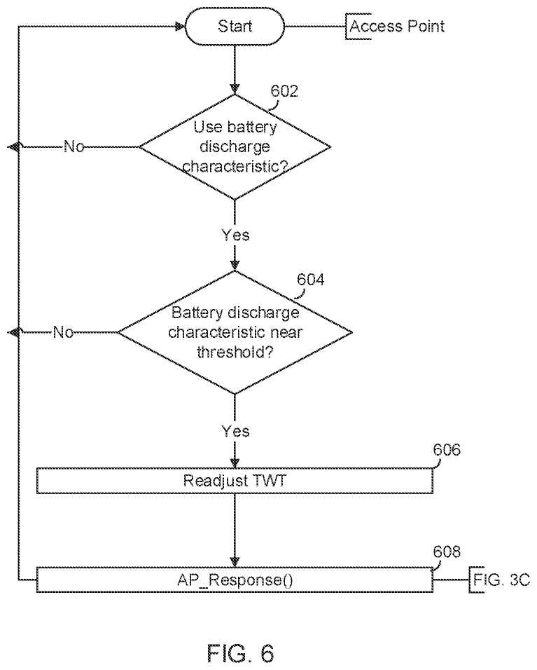

FIG. 6 depicts a flow of operations for an access point response to a low power warning from a battery discharge characteristic of a station, according to an embodiment. In this embodiment, access point 202 determines whether it uses a battery discharge characteristic of the station. For example, in FIG. 2, stations 210, 212, 214, 216 in group X may have one particular battery discharge characteristic, while stations 218, 220, 222, 224, 226 in group Y and stations 228, 230, 232, 234 in group Z may have different discharge characteristics over time. For example, stations in group X have battery discharge characteristics that exhibit a rapid reduction in voltage, like that of alkaline batteries. Stations in Y have discharge characteristics that exhibit a rapid reduction in voltage followed by a steep decline, like that of lithium-ion batteries. Stations in Z have discharge characteristics that exhibit a gradual reduction in voltage followed by a steep decline, like that of nickel-cadmium batteries.

Access points 202, 240, or WLC 244 may have pre-programmed battery discharge characteristics for common IoTs or may have learned the typical battery discharge characteristic for specific device types, such as iPhones, which have lithium-ion batteries. Consulting the battery discharge characteristic (learned or known) of the devices in Group X, Y, or Z gives access point 202 or WLC 244 the ability to predict a point later in time when the battery will drop below a lower power threshold.

Referring to FIG. 6, if access point 202 does use a battery discharge characteristic for a device as determined in block 602, then in block 604, access point 202 determines, based on the battery discharge characteristic, whether a battery in station 234 is about to fall below a threshold. Access point 202 then readjusts the TWT in block 606 to preserve the station battery before it drops below the low power threshold. In block 608, access point 202 responds to the low power condition of the device according to the blocks in FIG. 3C.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer-readable medium(s) having computer-readable program code embodied thereon.

Program code embodied on a computer-readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer-readable medium that can direct a computer, other programmable data processing apparatus, or other device to function in a particular manner, such that the instructions stored in the computer-readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational blocks to be performed on the computer, other programmable apparatus or other device to produce a computer-implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for managing battery power of a station in a wireless network, the method comprising:
receiving a message from the station operating in a power savings mode, the message indicating that the battery power at the station has fallen below a threshold and that the station can receive power over the wireless network, wherein the station, in response to the battery power having fallen below the threshold, wakes up a radio interface of the station to send the message;
transmitting, in response to the message, an action frame to the station indicating a channel and parameters for the station to receive power over the wireless network; and
providing power to the station over the wireless network according to the action frame.

2. The method of claim 1, wherein providing power to the station includes an access point wirelessly coupled to the station and providing the power.

3. The method of claim 2, wherein providing power to the station comprises sending a message to another access point wirelessly coupled to the station to provide power to the station, wherein the message includes a channel and a basic service set id of the another access point.

4. The method of claim 3, wherein the message indicates that the station associate a link of the another access point to obtain power from the another access point.

5. The method of claim 1,
wherein the station operating in a power savings mode has a current target wakeup time;
further comprising, when the current target wakeup time expires, starting a next target wakeup time with a longer time than the current target wakeup time to allow the station to spend more time in a low-power mode to conserve the battery power.

6. The method of claim 5, wherein the longer time is exponentially longer than the current target wakeup time.

7. The method of claim 1,
wherein the station operating in a power savings mode has a current target wakeup time;
further comprising:
receiving a message that the battery power of the station is above the threshold; and
readjusting the current target wakeup time to an original period when the battery power is above the threshold.

8. The method of claim 7, wherein the station operates with full-charge communication parameters when the battery power of the station is above the threshold.

9. A system for managing battery power of a station in a wireless network, the system comprising:
at least one station configured to connect to the wireless network; and
at least one access point configured to connect to the wireless network;
wherein the at least one access point is configured to:
receive a message from the at least one station operating in a power savings mode, the message indicating that the battery power at the at least one station has fallen below a threshold and that the at least one station can receive power over the wireless network, wherein the at least one station, in response to the battery power having fallen below the threshold, wakes up a radio interface of the at least one station to send the message;
transmit, in response to the message, an action frame to the at least one station indicating a channel and parameters for the at least one station to receive power over the wireless network; and
provide power to the at least one station over the wireless network according to the action frame.

10. The system of claim 9, wherein the at least one access point being configured to provide power to the at least one station comprises sending a message to another access point to provide power to the at least one station, wherein the message includes a channel and a basic service set id of the another access point.

11. The system of claim 10, wherein the message indicates that the at least one station associates a link of the another access point to obtain power from the another access point.

12. The system of claim 9,
wherein the at least one station operating in a power savings mode has a current target wakeup time;
further comprising, when the current target wakeup time expires, starting a next target wakeup time with a longer time than the current target wakeup time to allow the at least one station to spend more time in a low-power mode to conserve the battery power.

13. The system of claim 12, wherein the longer time is exponentially longer than the current target wakeup time.

14. The system of claim 13,
wherein the at least one station operating in a power savings mode has a current target wakeup time; and
wherein the at least one access point is further configured to:
receive a message that the battery power of the at least one station is above the threshold; and
readjust the current target wakeup time to an original period when the battery power is above the threshold.

15. A non-transitory computer-readable medium encoding instructions, which, when executed by a processor of an access point coupled to a wireless network, cause one or more access points to:
receive a message from a station operating in a power savings mode, the message indicating that battery power at the station has fallen below a threshold and that the station can receive power over the wireless network, wherein the station, in response to the battery power having fallen below the threshold, wakes up a radio interface of the station to send the message; and
transmit, in response to the message, an action frame to the station indicating a channel and parameters for the station to receive power over the wireless network; and
provide power to the station over the wireless network according to the action frame.

16. The non-transitory computer-readable medium of claim 15, wherein instructions causing the one or more access points to provide power to the station include instructions causing the one or more access points to send a message to another access point wirelessly coupled to the station to provide power to the station, wherein the message includes a channel and a basic service set id of the another access point.

17. The non-transitory computer-readable medium of claim 16, wherein the message indicates that the station associate a link of the another access point to obtain power from the another access point.

18. The non-transitory computer-readable medium of claim 15,
wherein the station operating in a power savings mode has a current target wakeup time;
wherein, when the current target wakeup time expires, instructions further cause the one or more access points to start a next target wakeup time with a longer time than the current target wakeup time to allow the station to spend more time in a low-power mode to conserve the battery power.

19. The non-transitory computer-readable medium of claim 18, wherein the longer time is exponentially longer than the current target wakeup time.

20. The non-transitory computer-readable medium of claim 15,
wherein the station operating in a power savings mode has a current target wakeup time;
wherein instructions further cause the one or more access points to:
receive a message that the battery power of the station is above the threshold; and
readjust the current target wakeup time to an original period when the battery power is above the threshold.
